(19) United States
(12) Patent Application Publication
(10) Pub. No.: US 2008/0058973 A1
(43) Pub. Date: Mar. 6, 2008

(54) Music playback system and music playback machine

(76) Inventors: Tomohiro Hirata, Osaka (JP); Makoto Fujiwara, Kyoto (JP); Kenichiro Uda, Osaka (JP)

Correspondence Address: MCDERMOTT WILL & EMERY LLP, 600 13TH STREET, NW, WASHINGTON, DC, 20005-3096, US

(21) Appl. No.: 11/896,016

(22) Filed: Aug. 29, 2007

(30) Foreign Application Priority Data
Aug. 29, 2006 (JP) 2006-232366

(51) Int. Cl. G06F 17/00

(52) U.S. Cl. 700/94

(57) ABSTRACT

A first LSI moves to an energy saving state after saving the header analysis result from a header information analysis unit in a header analysis result storage unit. While the first LSI is in the energy-saving state, a second LSI reads and plays back audio data that is stored in a memory device based on the header analysis result that is saved in the header analysis result storage unit.

### BACKGROUND OF THE INVENTION

1. Field of the Invention

This invention relates to a music playback system and music playback machine that reproduce audio files, each of which comprise a header and audio data, and more particularly to a technique for enabling long audio playback, while low power consumption is achieved.

2. Description of the Related Art

In recent years, in mobile telephones or portable audio players that have an audio playback function, audio data that is selected by a user is saved in a memory device such as an internal memory like an HDD or flash memory, or an external memory card such as a SD (Secure Digital) card via personal computer so that the music can be enjoyed easily even when away from home. It has become possible lately that contents downloaded via the Internet or communication networks for portable phones are saved in memory for listening and/or viewing. Here, some audio data that is saved in the memory device is configured in the form of a multiplexed audio file called MP4 or ASF (Advanced Streaming Format). The multiplexed audio file comprises compressed audio data and a header in which information and contents about the audio data are written.

FIG. 18 is a block diagram showing the construction of an example of a conventional music playback system that reproduces audio files. This music playback system comprises a high-performance LSI 70 and a memory device 30. The LSI 70 comprises a CPU 71, header information analysis unit 72, memory device controller 73 and audio playback unit 74. Audio files AF that are stored in the memory device 30 include audio data AD and an audio header AH in which information about the audio data AD is written. The LSI 70 performs audio playback by the CPU 71 reading audio files AF from the memory device 30, analyzing the header AH with the header information analysis unit 72, reading audio data AD from the memory device 30 according to the header analysis results, and sending that data to the audio playback device 40 by way of the audio playback unit 74.

In the meantime, the power consumption by this kind of high-performance LSI is generally very large, so audio playback over a long period of time is difficult. Therefore, a technique has been proposed in which audio playback over a long period of time is made possible by dividing the LSI into an LSI for performing analysis of headers of audio files that are stored in the memory device, and an LSI for uncompressing and reproducing audio data so as to reduce the processing load of each LSI. This technique is explained, for example, in a Japanese patent document (Japanese Patent Laid-Open Publication No. 2003-316395; hereinafter simply referred to as Prior Art).

FIG. 19 is a simplified diagram of the parts related to the present invention in the prior art. In the figure, reference numeral 10 is a first LSI that comprises a first CPU 11 and first LSI interface 12; 20 is a second LSI that comprises a DSP (Digital Signal Processor) 21a, a second LSI interface 22 and a second memory device controller 23; 30 is a memory device; 80 is a D/A converter; and 40 is an audio playback device

The first LSI 10 analyzes management information such as a file system of an audio file AF that is stored in the memory device 30, and generates reading control information, then reads audio data from the memory device 30, and gives that read data to the DSP 21a of the second LSI 20. Then, the DSP 21a uncompresses the audio file AF and sends the uncompressed file to the audio playback device 40 by way of the D/A converter 80. With this kind of construction, the processing load of the large power consuming first LSI 10 that comprises a first CPU 1 is reduced and audio playback can be performed over a long period of time.

However, in this prior art, the DSP 21a in the second LSI 20 cannot analyze the headers of audio files of various formats, and in order to make this possible, it is necessary to prepare a DSP corresponding to header analysis of each format.

Furthermore, in this prior art, the first LSI 10 performs analysis of management information such as the file system of an audio file that is stored in the memory device 30. Therefore, each time a sector size of audio files (for example, in units of 512 bytes) of the memory device 30 are read out and the DSP 21a is caused to process the audio files, it is necessary to activate the LSI 10, and cause it to analyze the management information of the audio file to be played back next, read the audio file from the memory device 30 and give it to the DSP 21a, which requests frequent activation of the first LSI 10

### SUMMARY OF THE INVENTION

Taking the above into consideration, it is the main object of the present invention to enable extending audio playback time by achieving audio playback under low power consumption.

The music playback system of this invention comprises:

a memory device that comprises a memory area for audio files each containing audio data and a header which is data for managing the audio data;

a first LSI that comprises a header information analysis unit that reads and analyzes a header from the memory device;

a second LSI that reads and plays back the audio data from the memory device based on the header analysis result by the header information analysis unit; and

a header analysis result storage unit; wherein

the first LSI saves the header analysis result from the header information analysis unit in the header analysis result storage unit, and then moves to an energy saving state; and

the second LSI reads and plays back the audio data that is saved in the memory device based on the header analysis result that is saved in the header analysis result storage unit, while the first LSI is in an energy-saving state.

The energy-saving state referred to in the present invention means a state in which required power supply is effectively reduced in such a way that power supplied to the first LSI is stopped or made at minimum level required by performing audio playback only by the second LSI.

The present invention has a form in which the header analysis result storage unit is provided in the memory device. In this form, the first LSI shares the task of analyzing the header of the audio file, and the second LSI shares the task of reading the audio file and playing back the audio data, which includes analysis of the file system management information of the audio file. The header information analysis unit of the first LSI analyzes the header of the audio file that was read from the memory device, and notifies the second LSI of the header analysis result, as well as saves the header analysis result in the header analysis result storage unit of the memory device. After the header analysis result has been saved, the first LSI moves to the energy-saving state. The second LSI reads the audio data from the memory device based on the header analysis result that is saved in the header analysis result storage unit of the memory device, and plays back the audio data. The first LSI is in the energy-saving state while the second LSI plays back the audio data. By doing this, frequent activation of the first LSI becomes unnecessary, and audio playback can be performed under an energy-saving condition. As a result, audio data can be played back over a long period of time.

The present invention has a form in which the header analysis result storage unit is provided in the second LSI. In this form, the first LSI shares the task of analyzing the header of an audio file, and the second LSI is assigned to the task of reading the audio file and playing back the audio data, which includes analysis of the file system management information of the audio file. The header information analysis unit of the first LSI analyzes the header of the audio file that was read from the memory device, and notifies the second LSI of the header analysis result, as well as saves the header analysis result in the header analysis result storage unit of the second LSI. After the header analysis result has been saved, the first LSI moves to the energy-saving state. The second LSI reads the audio data from the memory device based on the header analysis result that is saved in the header analysis storage unit, and plays back the audio data. The first LSI is in the energy-saving state while the second LSI plays back the audio data. By doing this, frequent activation of the first LSI becomes unnecessary, and audio playback can be performed under an energy-saving condition. As a result, audio data can be played back over a long period of time.

The present invention has a form in which after the results obtained from analysis of the headers of all of the audio files, that are stored in the memory device, with the header information analysis unit, have been stored in the header analysis results storage unit, the first LSI moves to the energy-saving state.

In this form, with respect to all of a plurality of audio files that are stored in the memory device, header analysis is sequentially performed in a lump, instead of performing header analysis of the audio files every unit of playback files. Therefore, when continuously playing back a plurality of audio files, the first LSI can be maintained in the energy-saving state, so operation can be performed with even lower power consumption and the length of the playback time can be further increased.

Moreover, there is an aspect that this invention further comprises a play list management unit that manages a play list created by the user from a group of audio files that are stored in the memory device; wherein

the header information analysis unit analyzes the headers of audio files that are stored in the memory device based on the play list in the play list management unit.

In this aspect, the user creates a play list from among the group of audio files that are stored in the memory device, and the play list management unit manages that play list. In performing header analysis in a lump, the headers of a plurality of audio files are analyzed on the basis of the play list. By doing this, while continuous playback based on a play list selected by the user is performed, the first LSI can be maintained in an energy-saving state.

Also, there is an aspect that the present invention further comprises a parallel processing control unit that, immediately after the playback process of one audio file begins, performs a control, to the memory device, for reading from the memory device the header of the audio file to be played back next, and sending the header to the header information analysis unit; wherein

the header information analysis unit analyzes the header of the audio file that is saved in the memory unit and that is to be played back next, and saves the header analysis result while the second LSI plays back an audio file; and

the first LSI moves to an energy-saving state after the header analysis result from the header information analysis unit has been saved.

In this form, the header information analysis unit analyzes the header of the audio file to be played back next before the first LSI moves to an energy-saving state, so after playback of the current audio file has finished, the second LSI can immediately start the playback process for the audio file to be played back next. By doing this, the time required before the next playback process starts can be shortened.

It is preferred that the parallel processing control unit is so configured that the process of the second LSI for reading from the memory device audio data of the current audio file to be played back takes priority over the process of the first LSI for reading from the memory device the header of the audio file to be played back next. With such construction, playback of the audio file currently being played back becomes stable.

Moreover, a music playback system of the present invention comprises:

a memory device that comprises a memory area for audio files that contain audio data and headers, which are data for managing the audio data, and a header analysis result storage unit;

a first LSI that has the memory device save the audio files; and

a second LSI that comprises a header information analysis unit that analyzes a header, and reads and plays back audio data from the memory device based on the header analysis result from the header information analysis unit; wherein

the first LSI sends the second LSI a request for saving asking the audio file that was read by the second LSI in the memory device;

the second LSI receives the saving request, and has the header information analysis unit analyze the header, and has the header analysis result storage unit of the memory device save the header analysis result;

the first LSI moves to an energy-saving state each time the process of saving a header analysis result is completed, and repeats the saving request every time there is an audio file to be saved next while in the energy-saving state, and also moves to the energy-saving state after giving a playback instruction to the second LSI if the second LSI plays back the audio file that is saved in the memory device when the first LSI is on its way to the energy-saving state; and

the second LSI reads and plays back audio data that is saved in the memory device based on the header analysis result saved in the header analysis result storage unit while the first LSI is in the energy-saving state.

In this construction, the first LSI moves to an energy-saving state after requesting that the audio file be saved in the memory device. The second LSI, by way of the header information analysis unit, analyzes the header of the audio file to be saved, and saves that header analysis result in the header analysis result storage unit of the memory device. By repeating the process described above, header analysis is performed for headers of a plurality of audio files, the header analysis results are saved and the audio files are saved, and each time this series of processes is finished, the first LSI moves to an energy-saving state. Also, when the user gives an instruction to play back an audio file that is saved in the memory device, the first LSI that was in the energy-saving state is activated and gives a playback instruction to the second LSI, and then again moves to the energy-saving state. The second LSI reads and plays back audio data from the memory device based on the header analysis result that is saved in the header analysis result storage unit of the memory device. While the second LSI is playing back the audio data, the first LSI is in the energy-saving state. Therefore, it is not necessary to frequently activate the first LSI, and audio files can be played back with low power consumption. As a result, audio playback can be performed over a long period of time. Furthermore, header analysis is not performed when playing back an audio file, but is performed before the playback process every time when saving the audio file, so when continuously playing back a plurality of audio files, the first LSI is continuously kept in the energy-saving state, so playback can be performed with even lower power consumption and over a longer period of time.

There is also a form wherein

the first LSI further comprises a header number list management unit that assigns a number to the header analysis result, and manages the header number;

the first LSI notifies the second LSI of the header number from the header number list management unit when the second LSI plays back an audio file, then moves to an energy-saving state; and

the second LSI reads the header analysis result from the header analysis result storage unit based on the notified header number from the first LSI, then based on the read header analysis result, reads and plays back the audio data that is stored in the memory device.

In this form, when selecting an audio file to be played back, the first LSI only needs to notify the second LSI of the management number of the audio file, which simplifies selection of an audio file to be played back.

There is a form wherein the first LSI selects header numbers at random from the header number list management unit and notifies the second LSI of the header numbers, and the second LSI plays back at random the audio files that correspond to the header numbers. In this form, audio files that are stored in the memory device can be played back at random.

Also, there is a form wherein

the first LSI further comprises a play list management unit that manages a play list that was created by the user by selecting audio files from among a group of audio files that are stored in the memory device; and

the first LSI selects header numbers in order that are managed by the header number list management unit according to the play list from the play list management unit, and notifies the second LSI of the header numbers. In this form, the second LSI can be notified of the header numbers in such order as are listed in the play list, and playback is continuously performed according to the play list created by the user.

Moreover, there is a form wherein

the first LSI further comprises a play list management unit that manages a play list that is created by the user extracting audio files from among a group of audio files stored in the memory device; and

the first LSI selects header numbers at random that are managed by the header number list management unit according to the play list from the play list management unit, and notifies the second LSI of the header numbers. In this form, playback processes can be performed at random within the play list created by the user.

A music playback machine of the present invention comprises:

any of the music playback systems described above; and

a key-input unit that is connected to the first LSI of the music playback system; wherein

the first LSI moves to an energy-saving state during playback of an audio file, and when there is key input to the key-input unit while in the energy-saving state, performs processing according to that key input.

Also, a music playback machine of the present invention comprises:

any of the music playback systems described above; and

a radio communication unit that is connected to the first LSI of the music playback system; wherein

the first LSI moves to an energy-saving state during playback of an audio file, and, when there is input of a radio signal to the radio communication unit, such as a signal from a radio base station and download of an audio file, while in the energy-saving state, performs processing according to that radio signal input.

With the present invention, the process of analyzing the header of an audio file and the process of playing back audio data are assigned to the first LSI and second LSI, respectively, and when the second LSI is playing back the audio data, the first LSI moves to an energy-saving state. By doing this, audio playback can be performed with low power consumption, and thus audio playback can be performed for a long period of time.

The music playback system of this invention is useful in portable music playback equipment or electronic equipment such as a mobile telephone having a music playback function that plays back audio files comprising a header and audio data. Also, the present invention is not limited to the use for a music playback system, and can also be applied to other uses such as the use for a mobile terminal that has a video playback function.

### BRIEF DESCRIPTION OF THE DRAWINGS

These and other objects of the present invention will be made clear by understanding the preferred embodiment of the present invention that will be explained in detail hereafter and manifested in the supplied claims. By implementing the present invention, the many advantages of the invention that were not touched upon in the specification will become obvious to those skilled in the art.

FIG. 1 is a block diagram showing the construction of a music playback system of a first embodiment of the invention;

FIG. 2 is a block diagram showing the construction of a music playback system of a variation of the first embodiment of the invention;

FIG. 3 is a block diagram showing the construction of a music playback system of a variation of the first embodiment of the invention;

FIG. 4 is a block diagram showing the construction of a music playback system of a variation of the first embodiment of the invention;

FIG. 5 is an operation sequence diagram that shows the operation of the music playback system of the first embodiment of the invention;

FIG. 6 is a block diagram showing the construction of a music playback system of a second embodiment of the invention;

FIG. 7 is an operation sequence diagram that shows the operation of the music playback system of the second embodiment of the invention;

FIG. 8 is an operation sequence diagram that shows the operation of the music playback system of a third embodiment of the invention;

FIG. 9 is a block diagram showing the construction of a music playback system of a fourth embodiment of the invention;

FIG. 10 is an operation sequence drawing that shows the operation of the music playback system of the fourth embodiment of the invention;

FIG. 11 is a block diagram showing the construction of a music playback system of a fifth embodiment of the invention;

FIG. 12 is an operation sequence diagram that shows the operation of the music playback system of the fifth embodiment of the invention;

FIG. 13 is a block diagram showing the construction of a music playback system of a sixth embodiment of the invention;

FIG. 14 is an operation sequence diagram that shows the operation of the music playback system of the sixth embodiment of the invention;

FIG. 15 is a block diagram showing the construction of a music playback system of a seventh embodiment of the invention;

FIG. 16 is a block diagram showing the construction of a music playback system of an eighth embodiment of the invention;

FIG. 17 is a block diagram showing the construction of a music playback machine of an embodiment of the invention;

FIG. 18 is a block diagram showing the construction of a conventional music playback system; and

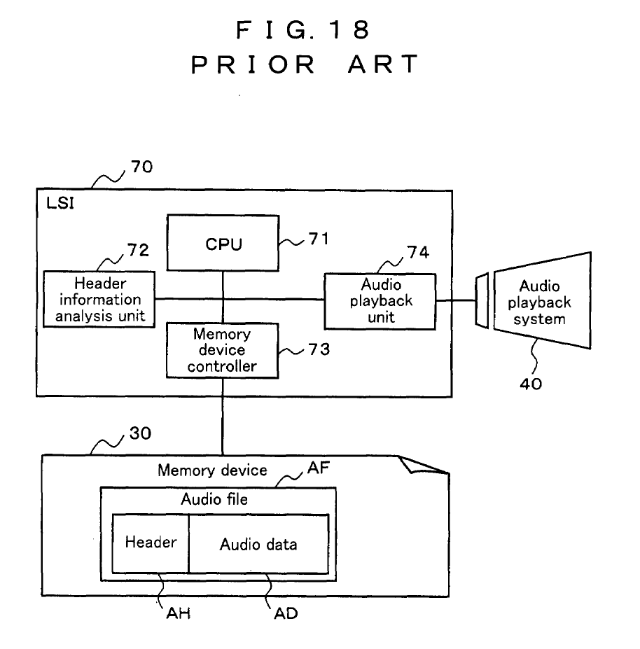

FIG. 19 is a block diagram showing another example of a conventional music playback system.

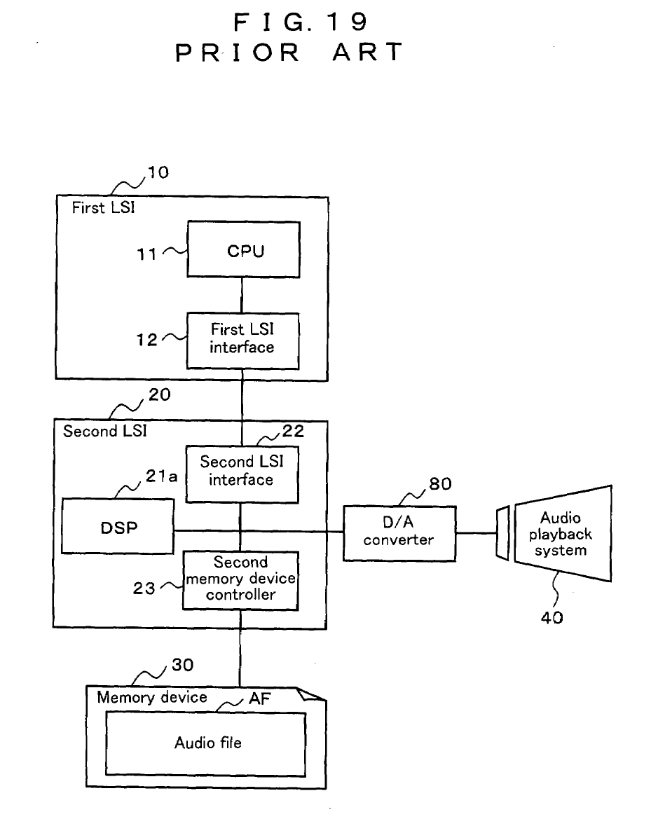

### DETAILED DESCRIPTION OF THE INVENTION

The preferred embodiments of the present invention concerning music playback system are explained in detail below with reference to the supplied drawings.

### Embodiment 1

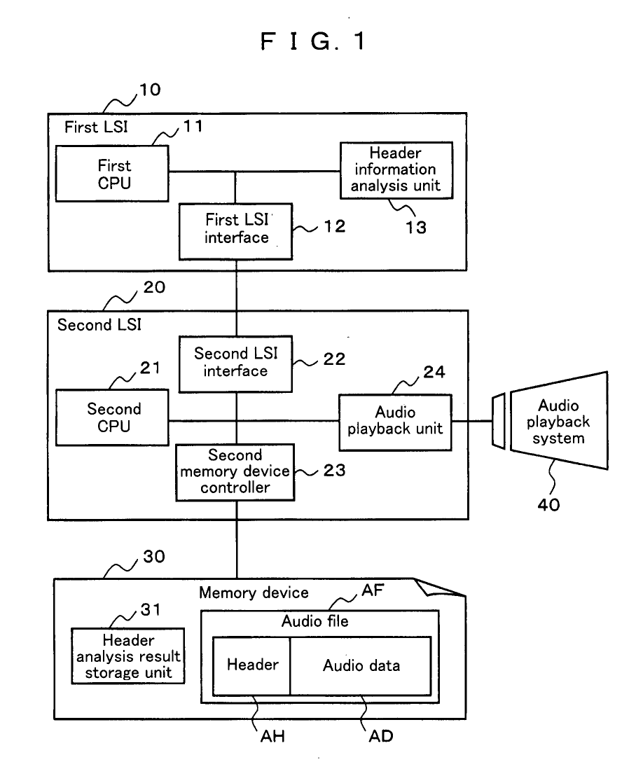

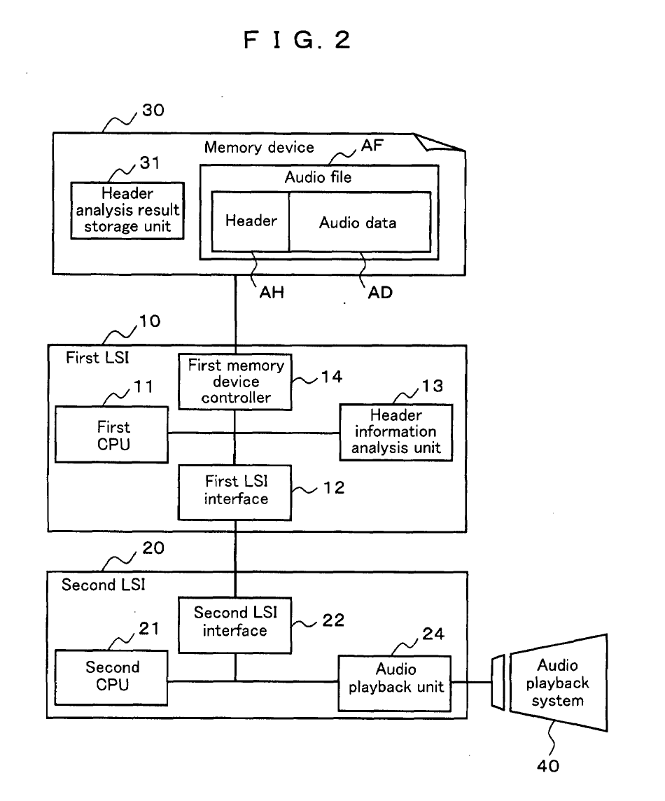

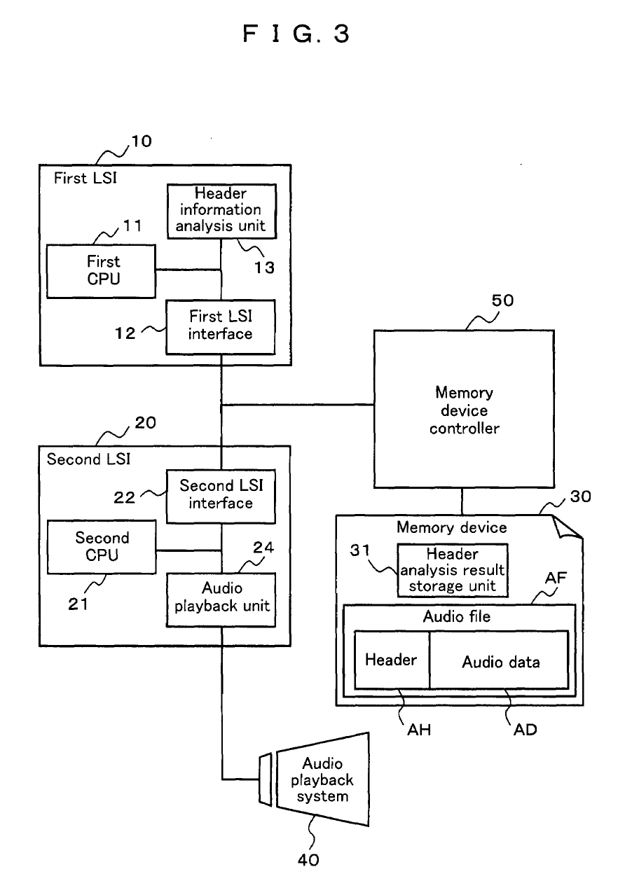

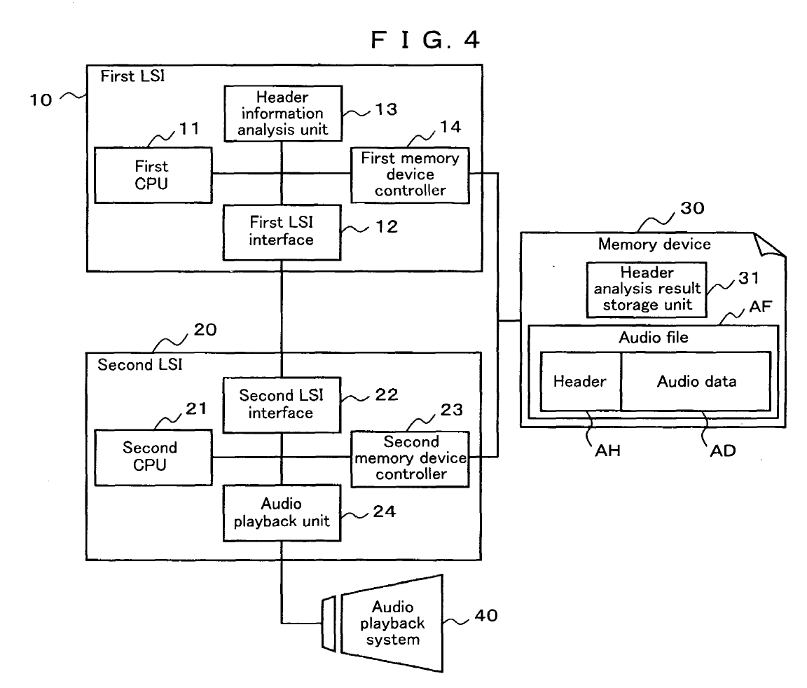

FIG. 1 is a block diagram showing the construction of a music playback system of a first embodiment of the invention. FIG. 2, FIG. 3 and FIG. 4 are block diagrams showing the construction of variations of a music playback system of a first embodiment of the invention. The music playback system of this embodiment comprises: a first LSI 10, a second LSI 20 and a memory device 30. The first LSI 10 comprises: a first CPU 11, a first LSI interface 12 and a header information analysis unit 13. The second LSI 20 comprises: a second CPU 21, a second LSI interface 22, a second memory device controller 23 and an audio playback unit 24. The memory device 30 stores audio files AF and comprises a header analysis result storage unit 31.

The first CPU 11 reads the header AH of an audio file AF that is stored in the memory device 30 by way of the first and second LSI interfaces 12, 22 and the second memory controller 23. The header information analysis unit 13 analyzes the header read by the first CPU 11, notifies the second CPU 21 of the header analysis result by way of the first and second LSI interfaces 12, 22, and saves the header analysis result in the header analysis result storage unit 31 by way of the second memory device controller 23.

The second CPU 21 accesses the header analysis result storage unit 31 by way of the second memory device controller 23, and based on the header analysis result saved there, reads audio data AD, then sends the read audio data AD to an audio playback device 40 by way of the audio playback unit 24. By doing this, the audio file is played back. In a music playback system having this kind of construction, while the second LSI 20 is playing back audio, the first LSI 10 is moved to an energy-saving state X.

In this embodiment, the second memory controller 23 can be outside the second LSI 20. For example, in the variation (music playback system ) shown in FIG. 2, the first LSI 10 has a first memory device controller 14, and this first memory device controller 14 controls the memory device 30. Also, in the variation (music playback system) shown in FIG. 3, there is a memory controller 50 outside the first LSI 10 and second LSI 20, and this memory device controller 50 controls the memory device 30. Moreover, in the variation (music playback system) shown in FIG. 4, there is a first memory device controller 14 inside the first LSI 10 and a second memory device controller 23 inside the second LSI 20. These memory device controllers 14, 23 are connected to the memory device by a wire door. These variations can be similarly applied to the embodiments described below.

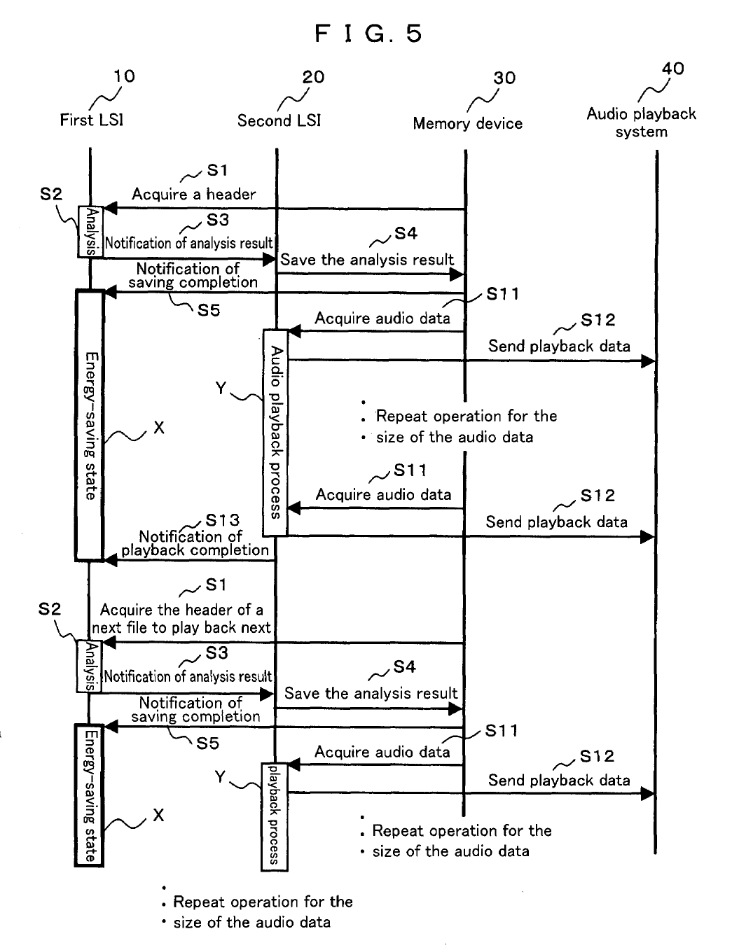

Next, the operation of the music playback system of the embodiment described above is explained according to the operation sequence diagram of FIG. 5. The header information analysis unit 13 acquires a header AH from the memory device 30 (step S1), and analyzes the header AH (step S2). The header information analysis unit 13 notifies the second CPU 21 of the header analysis result (step S3), and saves it in the memory device 30 (step S4). The memory device 30 sends a saving completion notification to the first LSI 10 (step S5). After receiving the saving completion notification from the memory device 30 (step S5), the first CPU 11 moves to the energy-saving state X.

The second CPU 21 acquires audio data from the memory device 30 according to the header analysis result that was stored in the memory device 30 (step S11), decompresses that audio data AD, generates playback data, and sends the generated playback data to the audio playback device 40 (step S12). The second CPU 21 repeats these audio playback processes Y for the size of the audio data, and after completing playback of the audio file AF, notifies the first LSI 10 that playback is completed (step S13). After receiving the notification that playback is completed (step S13), the first CPU 11 releases itself from the energy-saving state.

After that, the same sequence of operation described above is repeated for the next audio file to be played back. In other words, with the construction described above, by moving the first LSI 10 to an energy-saving state during audio playback process Y consuming the processing time, the power consumption of the overall music playback system is reduced, and as a result, audio playback can be performed over a long period of time. There is no need for a DSP for header analysis in the second LSI 20.

### Embodiment 2

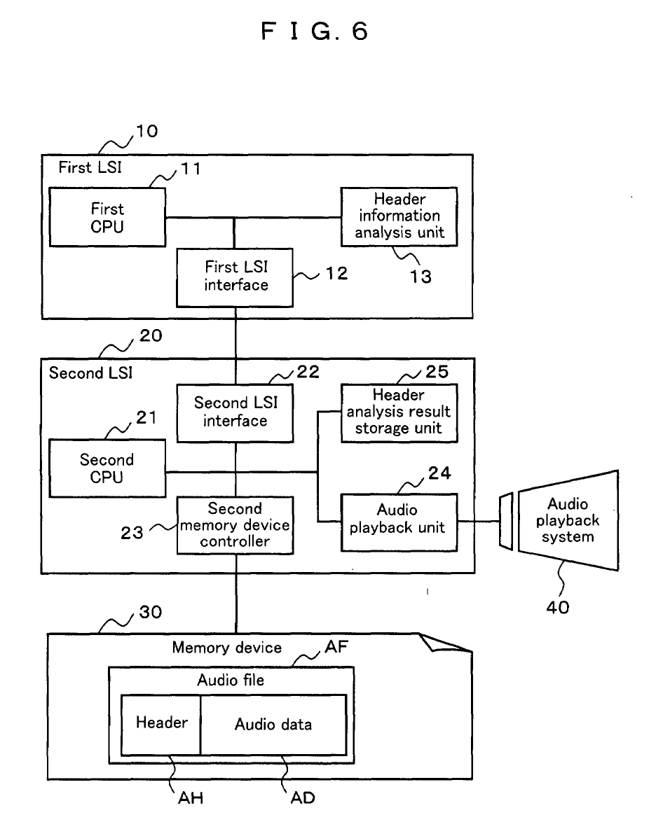

FIG. 6 is a block diagram showing the construction of a music playback system of a second embodiment of the invention. In FIG. 6, the same reference numbers as used in FIG. 1 of the first embodiment indicate the same components. In the first embodiment, a header analysis result storage unit 31 is provided in the memory device 30, but, in this second embodiment, a header analysis result storage unit 25 for saving header analysis results obtained by a header analysis result storage unit 31 and the header information analysis unit 13 are provided in the second LSI 20.

The second CPU 21, in accordance with header analysis results stored in the header analysis result storage unit 25, accesses the memory device 30 by way of the second memory device controller 23 and reads audio data AD. Furthermore, the second CPU 21 sends the read audio data AD to the audio playback device 40 by way of the audio playback unit 24. By doing this, the audio file AF is played back. In a music playback system having this kind of construction, the first LSI 10 is made to move an energy-saving state X during playing back audio data through the second LSI 20.

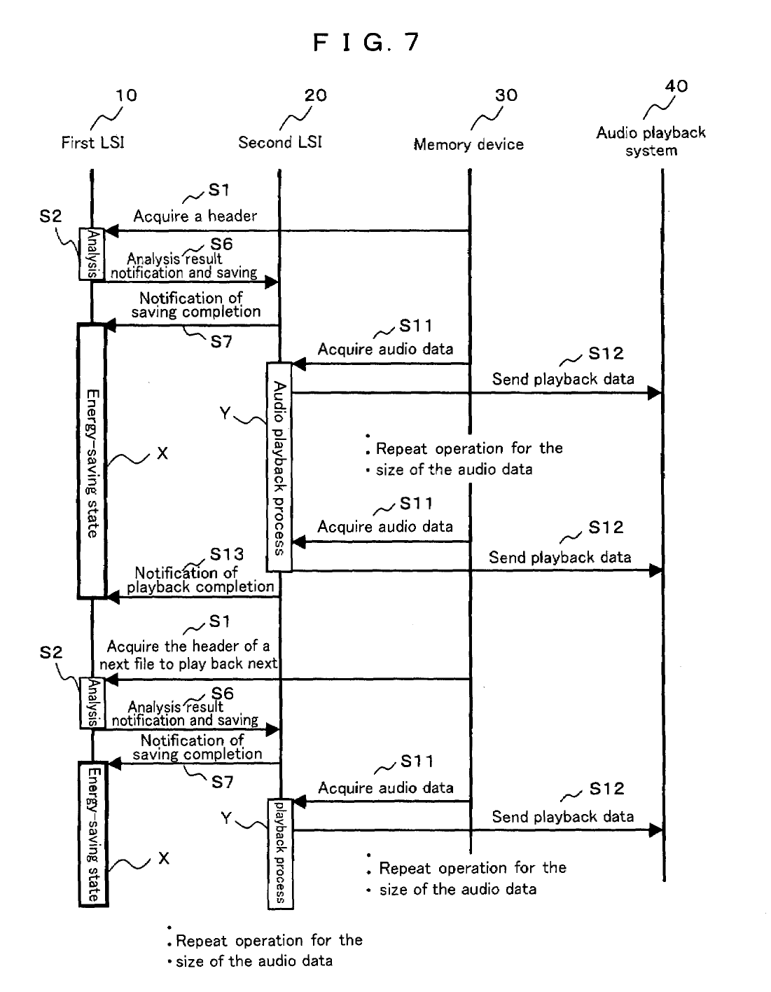

Next, the operation of the music playback system of this embodiment constructed as described above is explained according to the operation sequence diagram shown in FIG. 7. In this embodiment in relation to the first embodiment shown in FIG. 5 in notification and saving of the header analysis result in step S6 and notification of saving completion in step S7 are different.

The header information analysis unit 13 acquires a header AH from the memory device 30 (step S1) and analyses that header AH (step S2). The header information analysis unit 13 notifies the second CPU 21 of the second LSI 20 of the header analysis result, and saves the header analysis result in the header analysis result storage unit 25 (step S6). The second LSI 20 sends the saving completion notification to the first LSI 10 (step S7). After receiving the saving completion notification from the second LSI 20 (step S7), the first CPU 11 moves to an energy-saving state.

The second CPU 21 acquires audio data AD from the memory device unit 30 according to the header analysis result that is saved in the header analysis result storage unit 25 (step S1), and decompresses the audio data AD. The second CPU 21 sends playback data that is obtained through decompression to the audio playback device 40 (step S12). The second CPU 21 repeats this kind of audio playback processing Y for the size of the audio data, and when playback of the audio file AF is completed, notifies the first LSI 10 that playback is completed (step S13). After receiving the playback completion notification (step S13), the first CPU 11 releases the energy-saving state X.

After that, the same sequence of operation described above is repeated for the next audio file to be played back. In this way, by moving the first LSI 10 to an energy-saving state while the time consuming audio playback process Y being performed, the power consumption of the overall music playback system is reduced, and as a result, audio playback can be performed over a long period of time. There is no need for a DSP for header analysis in the second LSI 20.

### Embodiment 3

The music playback system of a third embodiment of the invention has the same construction as that of the first embodiment (FIG. 1), and, in the third embodiment, when a plurality of audio files are stored in the memory device 30, all of the plurality of audio files are sequentially analyzed in a lump with the headers AH.

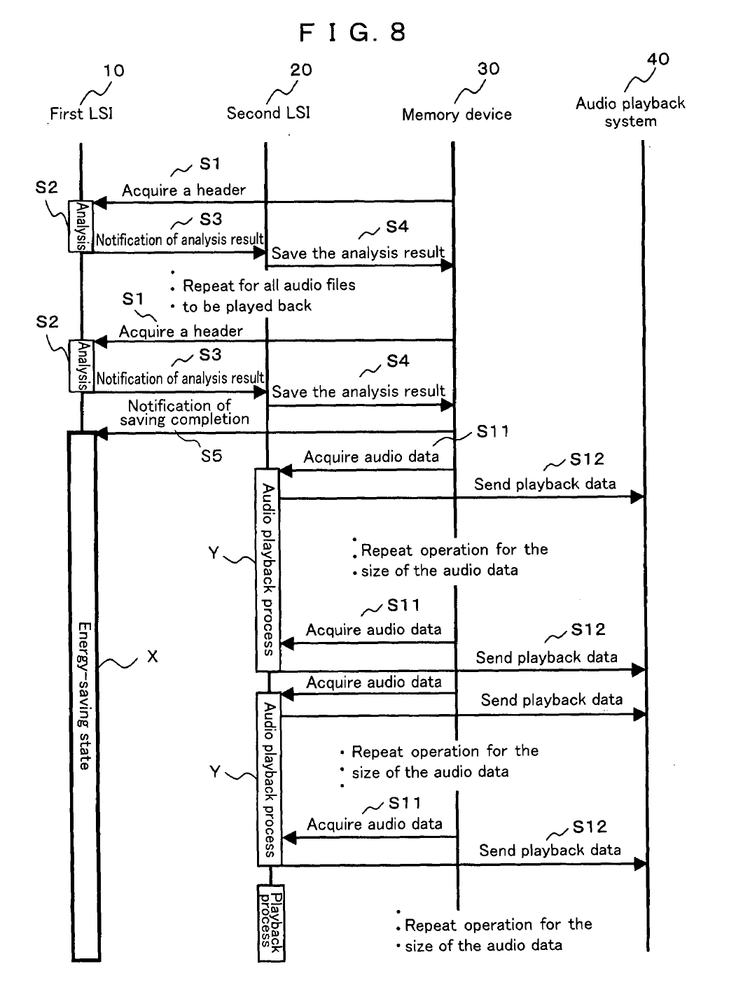

Next, the operation of the music playback system of the embodiment having the construction described above will be explained according to the operation sequence diagram shown in FIG. 8. The header information analysis unit 13 acquires a header AH from the memory device 30 (step S1), and analyzes the header AH (step S2). The header information analysis unit 13 notifies the second CPU 21 of this header analysis result (step S3), and saves the header analysis result in the memory device 30 (step S4). The header information analysis unit 13 repeats the series of processes from the process of acquiring the header AH to processing the header analysis result (steps S1 to S4) for the number of audio files held in the memory device 30.

After header analysis of all of the audio files AF held in the memory device 30 is completed, the memory device 30 notifies the first LSI 10 that saving is completed (step S5). After receiving the saving completion notification from the memory device 30 (step S5), the first CPU 11 moves to the energy-saving state X.

The second CPU 21 acquires audio data AD from the memory device 30 according the header analysis results held in the memory device 30 (step S11), then decompresses the acquired audio data AD and sends the decompressed playback data to the audio playback device 40 (step S12). The second CPU 21 repeats the audio playback process Y for the size of the audio data.

After playback of one audio file AF is completed, the sequence of operation described above is repeated for the next audio file AF to be played back. By repeating the process described above for all of the audio files AF that are held in the memory device 30 according to the saved header analysis results, the second CPU 21 plays back audio data. Therefore, the first LSI 10 can be maintained in the energy-saving state X for a long time.

With this embodiment, with respect to all of a plurality of audio files AF held in a memory device 30, header analysis is sequentially performed in a lump instead of performing header analysis of an audio file in each unit of playback files, the first LSI 10 can be maintained in an energy-saving state X while continuously playing back a plurality of audio files AF, and thus playback can be performed over a long period with low power consumption.

### Embodiment 4

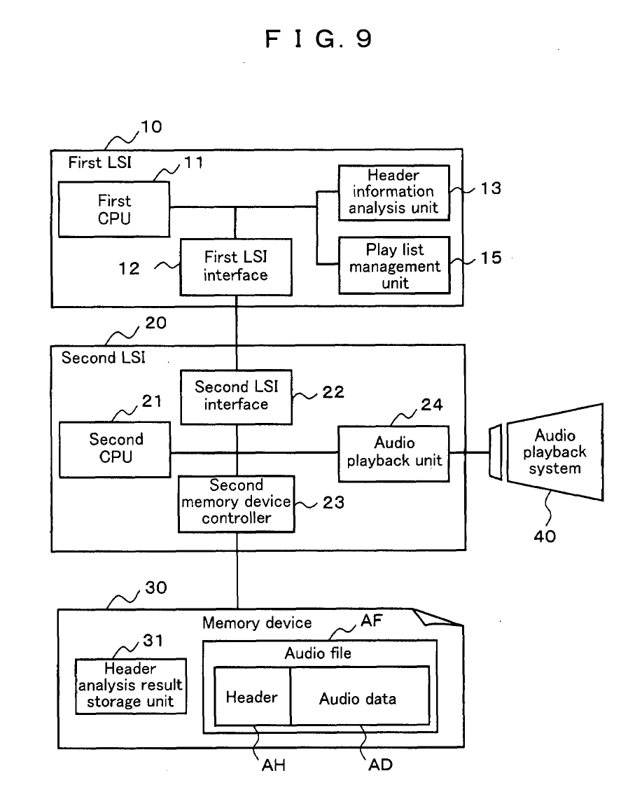

FIG. 9 is a block diagram showing the construction of a music playback system of a fourth embodiment of the invention. In FIG. 9 the same reference numbers as those in the first embodiment shown in FIG. 1 indicate the same components. In this embodiment, the first LSI 10 comprises a play list management unit 15. The play list management unit 15 manages a play list that is created by the user from among all of the audio files AF that are held in a memory device 30. A first CPU 11 refers to the play list in the play list management unit 15, and reads the headers AH of all of the audio files held in the memory unit 30. A header information analysis unit 13 performs analysis of the headers AH read by the first CPU 11. In the music playback system having this kind of construction, the first LSI 10 is moved to an energy-saving station X while the second LSI 20 performs audio playback.

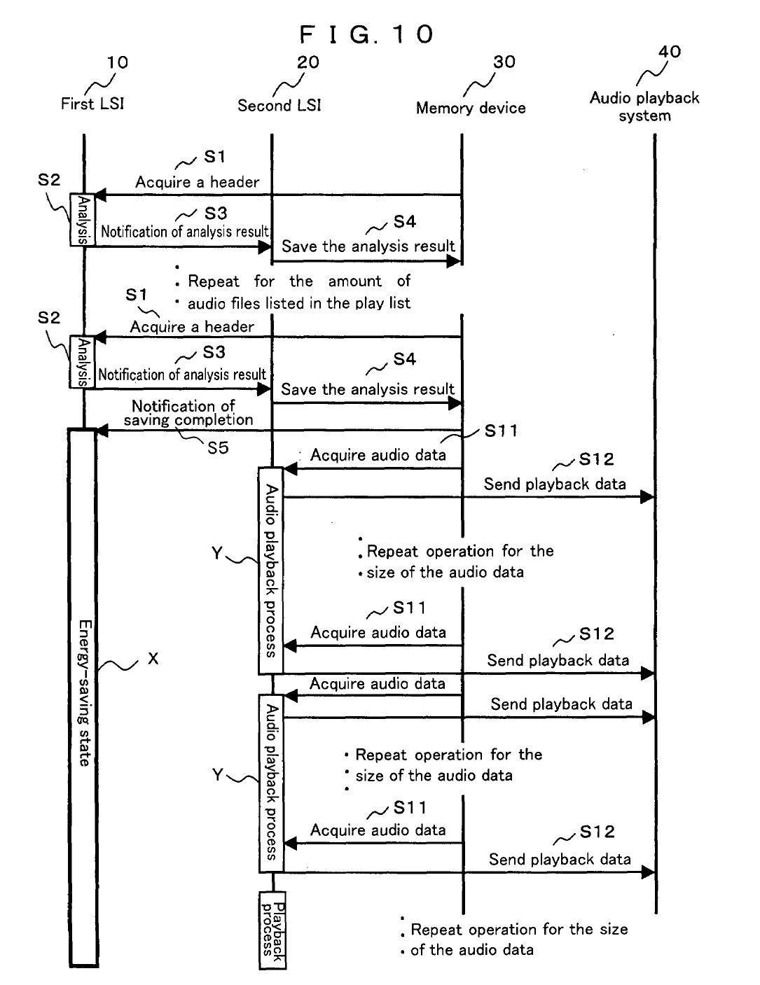

Next, the operation of the music playback system of this embodiment constructed as described above is explained according to the operation sequence diagram shown in FIG. 10. The header information analysis unit 13 acquires a header AH from the memory device 30 (step S1), analyzes the header AH (step S2) and then notifies the second CPU 21 of the header analysis result (step S3), and saves the header analysis result in the memory device 30 (step S4). This series of processes from the process of acquiring a header AH to processing the header analysis result (steps S1 to S4) is repeated for the number of audio files AF listed in the play list in the play list management unit 15.

After header analysis of all of the audio files AF that are listed in the play list is completed, the memory device 30 notifies the first LSI 10 that saving is completed (step S5). After receiving the saving completion notification (step S5), the first CPU 11 moves to an energy-saving state X.

The second CPU 21 acquires audio data AD from the memory device 30 according to the header analysis result held in the memory device 30 (step S11). Furthermore, the second CPU 21 decompresses the audio data AD, and sends the obtained playback data to the audio playback unit 40 (step S12). These audio playback processes Y (steps S11 and S12) are repeated for the size of the audio data.

After the playback of one audio file AF is completed, the sequence of operation described above is repeated for the next audio file AF to be played back. The second CPU 21 repeatedly performs audio playback for all of the audio files AF listed in the play list of the play list management unit 15 according to the saved header analysis results. By doing so, the first LSI 10 can be maintained in an energy-saving state X, and audio playback is performed according to the play list that is created by the user.

In this embodiment, the play list management unit 15 manages a play list that is created by the user from a group of audio files AF held in the memory device 30, when header analysis is performed by one operation for a plurality of audio files lumped together, the headers are analyzed with reference to the play list. By doing this, when performing continuous playback of a play list specified by the user, the first LSI 10 can be maintained in an energy-saving state X.

### Embodiment 5

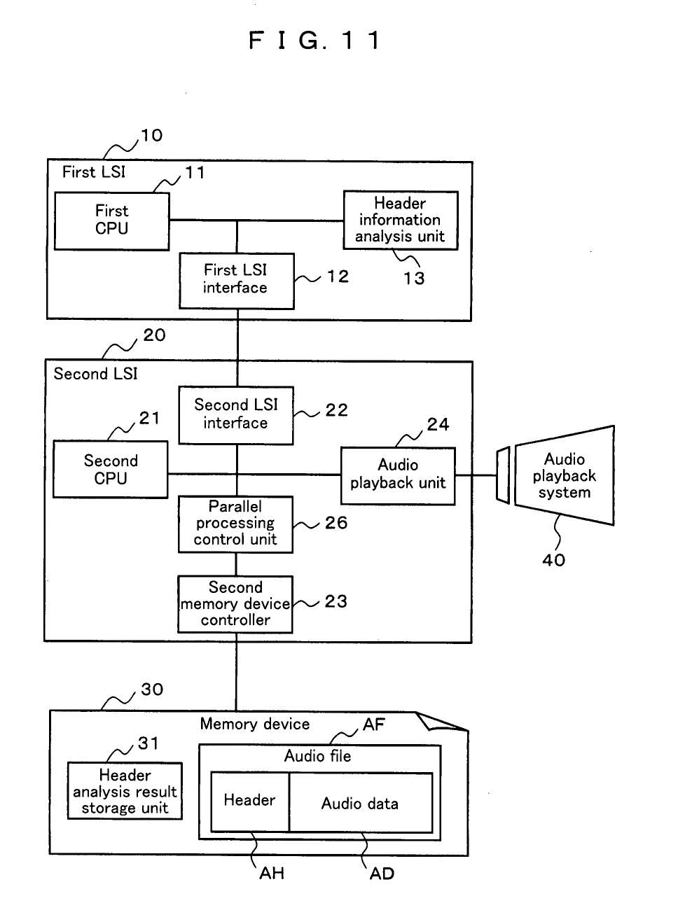

FIG. 11 is a block diagram showing the construction of a music playback system of a fifth embodiment of the invention. In FIG. 11 the same reference numbers as those in the first embodiment shown in FIG. 1 indicate the same components. In this embodiment, the second LSI 20 comprises a parallel processing control unit 26. Immediately after the second LSI 20 starts the playback process for one audio file AF, this parallel processing control unit 26 notifies the first LSI 10 that the first LSI 10 should perform analysis of the header of the next audio file AF to be played back, then reads the header AH of that audio file AF from the memory device 30, and controls the memory device 30 so that header AH is sent to the header information analysis unit 13 of the first LSI 10. Also, the parallel processing control unit 26 performs the following control for stabilizing audio playback. In other words, the parallel processing control unit 26 performs control so that the process of the second LSI 20 reading from the memory device 30 audio data AD of the audio file AF to be played back currently take priority over the process of the first LSI 10 reading from memory device 30 the header AH of the audio file to be played back next.

After the first CPU 11 receives notification from the parallel processing control unit 26 during audio playback by the second LSI 20, the header information analysis unit 13 performs the following processes:

Analyzes the header AH of the audio file AF to be played back next,

Notifies the second CPU 21 of the header analysis result, and

Saves the header analysis result in the header analysis result storage unit 31 of the memory device 30.

After that the first LSI 10 is moved to an energy-saving state X.

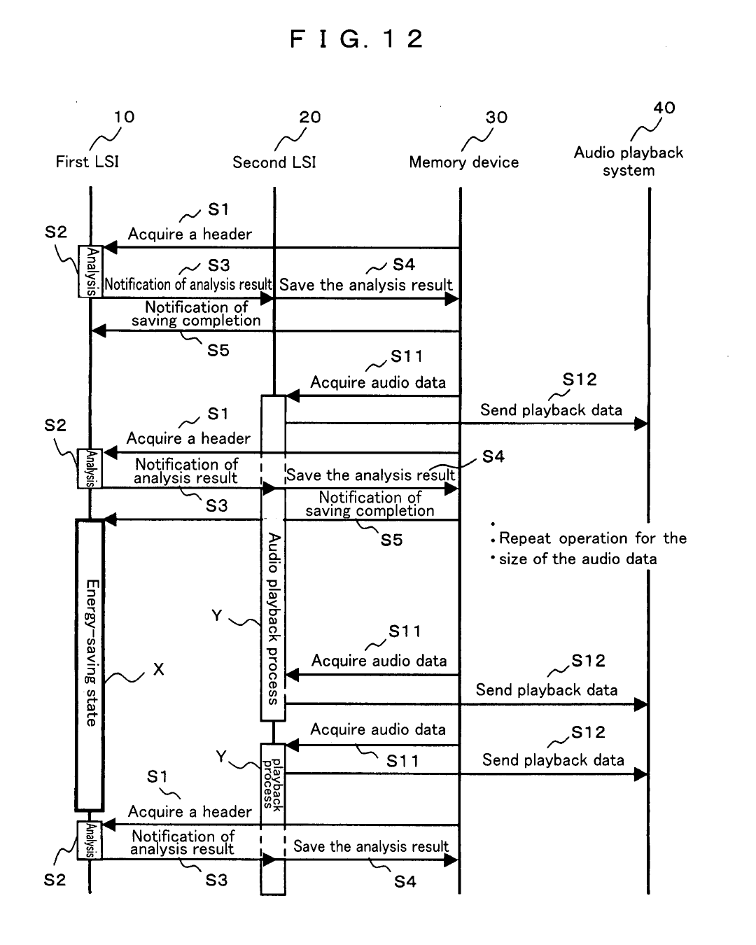

Next, the operation of the music playback system of this embodiment constructed as described above will be explained according to the operation sequence diagram shown in FIG. 12. The header information analysis unit 13 acquires a header AH from the memory device 30 (step S1), and analyzes the header AH (step S2). The header information analysis unit 13 notifies the second CPU 21 of the header analysis result (step S3), and saves the header analysis result in the header analysis result storage unit 31 of the memory device 30 (step S4). The memory device 30 sends a saving completion notification to the first LSI 10 (step S5).

Next, the second LSI 20 advances to audio playback processing Y. In other words, the second CPU 21 acquires audio data from the memory device 30 according to the header analysis result of the first LSI 10 (step S11), decompresses the audio data AD, and sends the playback data obtained from the decompression to the audio playback device 40 (step S12).

In this embodiment, after this, without immediately moving to an energy-saving state X, in parallel with the way that the second LSI 20 performs audio playback processing Y, the first LSI 10 acquires from the memory device 30 the header AH of the audio file AF to be played back next (step S1), analyzes the acquired header AH (step S2), notifies the second CPU 21 of the header analysis result (step S3), and saves that header analysis result in the saving completion notification memory region of the memory device 30 (step S4).

In this embodiment, the execution of the process of acquiring audio data (step S11) and the process of sending playback data (step S12) has priority over the execution of the second process of acquiring a header (step S1) and the second process of analyzing the header (step S2). After receiving the saving completion notification from the memory device 30 (step S5), the first LSI 10 moves to an energy-saving state X.

After that, while the second LSI 20 is performing the audio playback process Y, the first LSI 10 is kept in the energy-saving state X. When playback of the audio file AF is completed, the second LSI 20 moves to the process for playing back a audio file AF to be played back next. Analysis of the header AH of an audio file AF to be played back next is already finished and the header analysis result is saved in the header analysis result storage unit 31 of the memory device 30, so the second LSI 20 can perform the process for playing back an audio file AF to be played back next. Since analysis of a header is already finished in this way, the time required before the start of the next audio playback process can be shortened.

As was explained above, in this embodiment, when the next audio playback process starts, analysis of the header AH of the audio file AF to be played back next is performed, so the first LSI 10 releases itself from the energy-saving state X. After being released from the energy-saving state X, the first LSI 10 performs the process of acquiring the header AH of the audio file AF to be played back next (step S1), and the process of analyzing that header AH (step S2). After that header analysis is finished, the first LSI 10 moves again to the energy-saving state X. After that, the sequence of operation described above is repeated.

With this embodiment, by having the first LSI 10 move to an energy-saving state while the second LSI 20 is performing the time consuming audio playback process, the power consumption of the overall music playback system can be reduced, and as a result, audio playback can be performed for a long period of time.

Also, before the first LSI 10 moves to the energy-saving state X, the first LSI 10 in advance analyzes the header AH of the audio file AF to be played back next, so after the playback process Y of the current audio file AF is completed, the second LSI 20 can move immediately to the playback process Y for the audio file AF to be played back next, and thus the time required before the start of the next audio playback process can be shortened.

Also, in the parallel processing control unit 26, the process of acquiring audio data AD (step S11) by the second LSI 20 takes priority over the process of acquiring a header AH (step S1) and analyzing that header (step S2) by the first LSI 10, so the audio playback process Y can be made stable.

### Embodiment 6

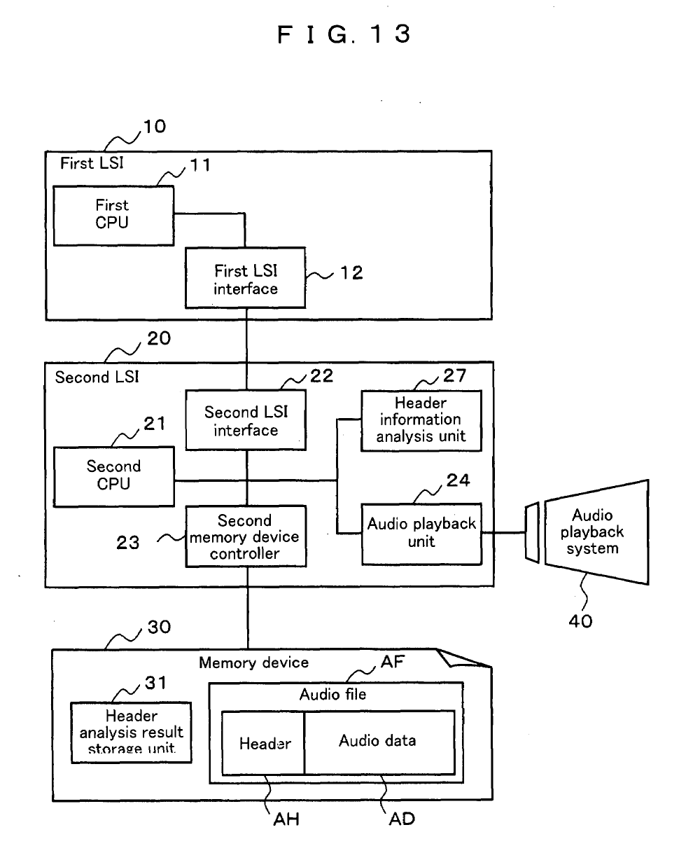

FIG. 13 is a block diagram showing the construction of a music playback system of a sixth embodiment of the invention. In FIG. 13 the reference numbers that are the same as those of the first embodiment shown in FIG. 1 indicate the same components. While in the first embodiment, there is a header information analysis unit 13 in the first LSI 10, in this embodiment, there is a header information analysis unit 27 in the second LSI 20. The header information analysis unit 27 analyzes the header AH of the audio file AF when the first LSI 10 saves the audio file AF in the memory device 30. After saving the audio file AF and header analysis result of the header AH in the header analysis result storage unit 31 of the memory device 30, the first LSI 10 moves to an energy-saving state X.

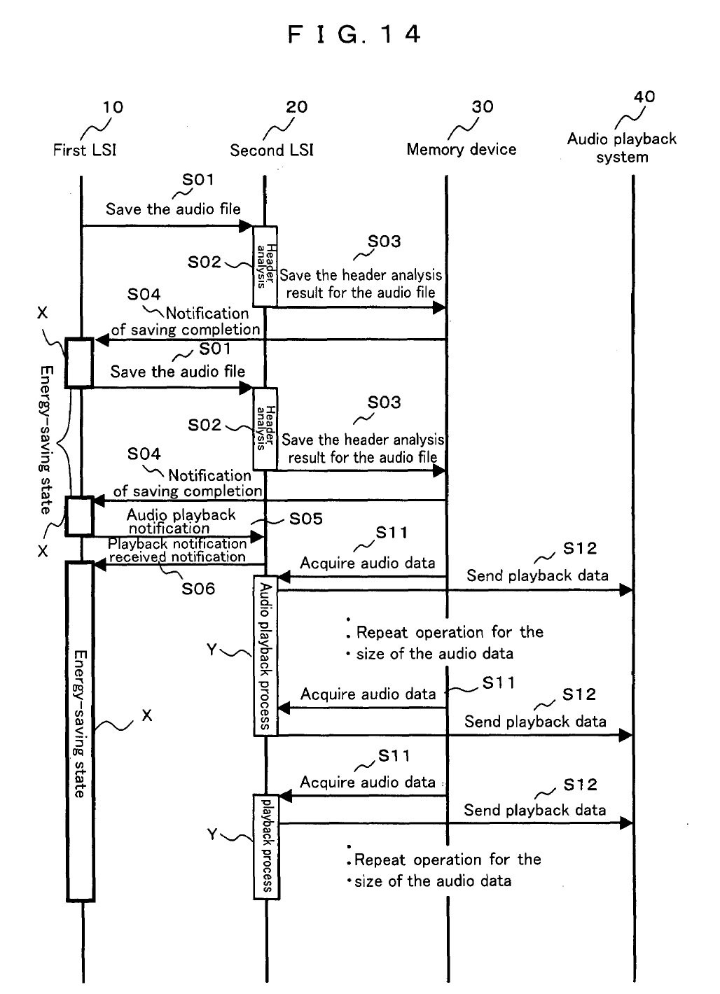

Next, the operation of the music playback system of this embodiment that is constructed as described above is explained according to the operation sequence diagram shown in FIG. 14. The first CPU 11 requests the second LSI 20 to save an audio file AF (Step S01). The second CPU 21 performs header analysis of the header of that audio file AF (step S02), and saves the audio file AF and header analysis result in the header analysis result storage unit 31 of the memory device 30 (step S03). After the saving process is finished, the memory device 30 notifies the first LSI 10 that saving is finished (step S04). After that, the first LSI 10 moves to an energy-saving state X.

After receiving the audio file AF to be played back next, the first LSI 10 is released from the energy-saving state and the same sequence of operation as described above is repeated. After that, the first CPU 11 releases itself from the energy-saving state X in response to playback start operation by the user, and notifies the second LSI 20 of audio playback (step S05). After receiving notification from the second LSI 20 that the playback notification was received (step S06), the first LSI 10 moves again to the energy-saving state.

The second CPU 21 performs the audio playback process Y according to the received audio playback notification (step S05). In other words, the second CPU 21 acquires audio data AD from the memory device 30 (step S11) according to the header analysis result stored in the memory device 30, decompresses the acquired audio data AD, and sends the playback data obtained from decompression to the audio playback device 40 (step S12). These audio playback processes Y (steps S11 to S12) are repeated for the size of the audio data. When playback of one audio file AF is completed, the sequence of operation described above is repeated for the audio file AF to be played back next.

With this embodiment, by having the first LSI 10 move to an energy-saving state X during the time consuming audio playback processing Y, the power consumption of the overall music playback system can be reduced, and as a result, audio playback can be performed for a long period of time.

Also, by having the second LSI 20 perform header analysis (step S02) when saving the audio file AF, the amount of time required before playback begins can be shortened by the same amount that the header analysis processing time necessary for audio playback can be shortened. In addition, the processing load imposed on the first LSI 10 during playback of an audio file AF can be reduced.

Also, header analysis of the header AH of an audio file AF is performed when storing the audio file AF in the memory device 30 in the initial stage, and the header analysis result is stored in the header analysis result storage unit 31 of the memory device 30, so in audio playback processing Y for a plurality of audio files AF, the plurality of audio playback processing Y can be executed continuously while keeping the first LSI 10 in an energy-saving state X.

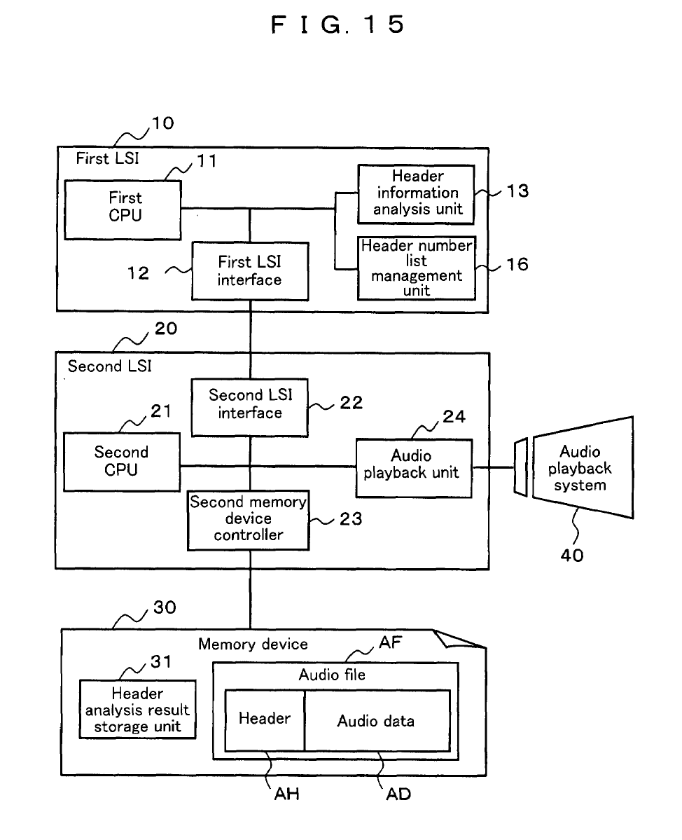

FIG. 15 is a block diagram showing the construction of a music playback system of a seventh embodiment of the invention. In FIG. 15, reference numbers that are the same as those for the first embodiment shown in FIG. 1 indicate the same components. In this embodiment, the first LSI 10 comprises a header number management unit 16. The header number management unit 16 assigns header numbers to the header analysis results of the header analysis performed by the header analysis unit 13 and manages those header numbers.

The first CPU 11 reads the header AH of an audio file stored in the memory device 30 by way of a first and second LSI interfaces 12, 22 and a second memory device controller 23. The header information analysis unit 13 analyzes the header AH that was read by the first CPU 11. Then the header analysis unit 13 notifies the second CPU 21 of the header analysis result, and saves the header analysis result in the header analysis result storage unit 31 of the memory device 30. Also, the header information analysis unit 13 assigns a number to the header analysis result, and makes a header number list management unit 16 prepare a list of the number and manage the numbers through the list.

During audio playback, the first CPU 11 notifies the second CPU 21 of the header number that is saved by the header number list management unit 16. The second CPU 21 receives the notification of the header number, and based on that header number, accesses the header analysis result storage unit 31 and reads the header analysis result that is saved in the header analysis result storage unit 31. Moreover, based on the read header analysis result, the second CPU 21 reads audio data AD from the memory device 30 by way of the second memory device controller 23, and sends the read audio data AD to the audio playback device 40 by way of the audio playback unit 24. By doing this, the audio file is played back. During audio playback by the second LSI 20, the first LSI 10 moves to an energy-saving state X.

By having the first CPU 11 notify the second CPU 21 of just the management number of the audio file AF, selection of the audio file AF to be played back becomes simple.

Also, by having the first CPU 11 select at random a number from those numbers that are saved in the header number list management unit 16 and notify the second CPU 21 of that number, audio data AD that is stored in the memory device 30 can be played back at random.

### Embodiment 8

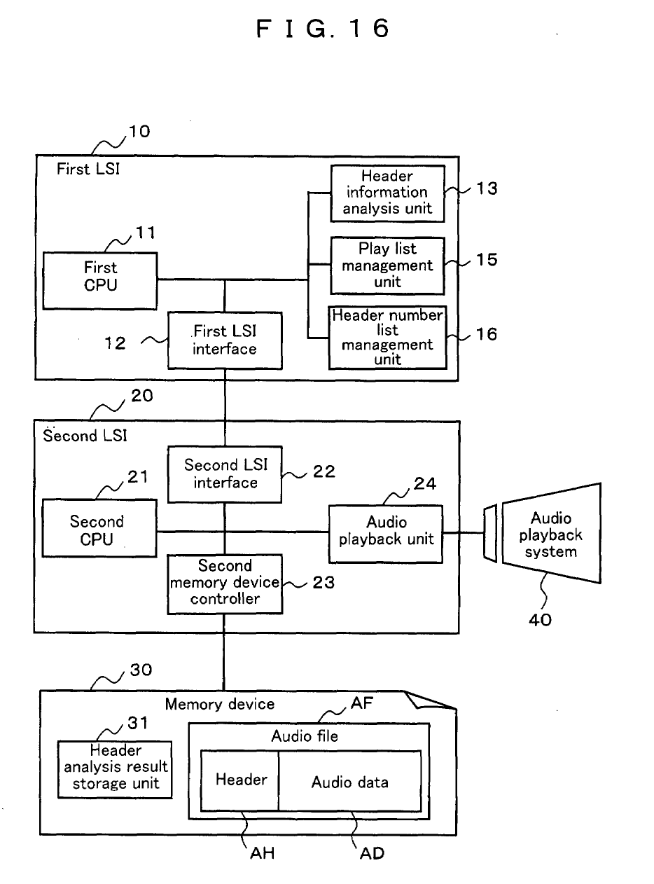

FIG. 16 is a block diagram showing the construction of a music playback system of an eighth embodiment of the invention. In FIG. 16, reference numbers that are the same as those of the seventh embodiment shown in FIG. 15 indicate the same components. The first LSI 10 under this embodiment further comprises a play list management unit 15 that manages the play list that is created by the user from among all of the audio files that are saved in the memory device 30. The first CPU 11 selects in order numbers that are saved in the header number list management unit 16 according to the play list that is managed by the play list management unit 15, and notifies the second CPU 21 of the numbers. By doing this, the audio files AF that are listed in the play list can be played back.

Alternatively, by having the first CPU 11 randomly select numbers from those numbers that are saved in the header number list management unit 16 according to the play list in the play list management unit 15, the audio files AF that are listed in the play list can be played back at random.

### Other Embodiments

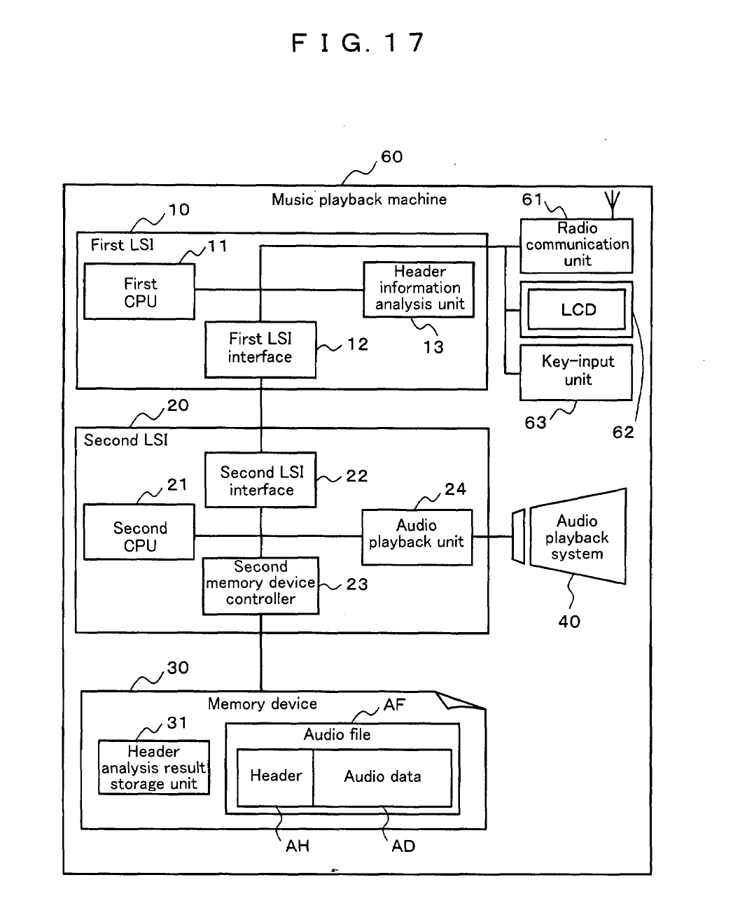

This invention can be applied to a music playback machine as shown in FIG. 17, for example. In FIG. 17, the first CPU 11 controls a radio communication unit 61, liquid-crystal display device (LCD) 62, and key-input unit 63, and analyzes headers AH of audio files that are saved in the memory device 30.

During audio playback processing by the second LSI 20, the first CPU 11 moves to an energy-saving state, and when an external event occurs such as input of a radio communication signal, key input or the like, the first CPU 11 returns from the energy-saving state and performs processing that deals with the external event.

By doing this, during audio playback, the first LSI moves to an energy-saving state, and power consumption of the music playback system is reduced. As a result, audio playback can be performed for a long period of time.

The most preferred embodiments of the present invention have been explained in detail; however, combinations and arrangements of parts of these preferred embodiments can be changed in various ways within the spirit and scope of the invention as claimed.

What is claimed is:

1. A music playback system comprising:
a memory device that comprises a memory area for audio files that contain audio data and a header, which is data for managing the audio data;
a first LSI that comprises a header information analysis unit that reads and analyzes a header from said memory device;
a second LSI that reads and plays back the audio data from the memory device based on the header analysis result by the header information analysis unit; and
a header analysis result storage unit; wherein the first LSI saves the header analysis result from the header information analysis unit in the header analysis result storage unit, and then moves to an energy saving state; and
the second LSI reads and plays back the audio data that is saved in the memory device based on the header analysis result that is saved in the header analysis result storage unit while the first LSI is in energy-saving state.

2. The music playback system of claim 1 wherein the header analysis result storage unit is provided in the memory device.

3. The music playback system of claim 1 wherein the header analysis result storage unit is provided in the second LSI.

4. The music playback system of claim 1 wherein after the headers of all the audio files that are held in the memory device are analyzed by the header information analysis unit and the analysis results are saved in the header analysis result storage unit, the first LSI moves to the energy-saving state.

5. The music playback system of claim 1 further comprising
a play list management unit that manages a play list that is created by the user from among a group of audio files that are held in the memory device; wherein
the header information analysis unit analyzes the headers of the audio files that are held in the memory device based on the play list in the play list management unit.

6. The music playback system of claim 1 further comprising
a parallel processing control unit that, immediately after one audio file begins to be played back, reads the header of the next audio file to be played back from the memory device and controls the memory device so that the read-out header is sent to the header information analysis unit; wherein
the header information analysis unit performs header analysis of the audio file that is stored in the memory device and is to be played back next, and saves that header analysis result while the second LSI plays back the audio file; and
the first LSI moves to an energy-saving state after the header analysis result from the header information analysis unit has been saved.

7. The music playback system of claim 6 wherein the parallel processing control unit is so configured that the process of the second LSI reading from the memory device audio data of the current audio file to be played back takes priority over the process of the first LSI reading from the memory device the header of the audio file to be played back next.

8. A music playback system comprising:
a memory device that comprises a memory area for audio files that contain audio data and headers, which are data for managing the audio data, and a header analysis result storage unit;
a first LSI that has the memory device save the audio files; and
a second LSI that comprises a header information analysis unit that analyzes the headers and reads and plays back audio data from the memory device based on the header analysis result from the header information analysis unit; wherein
the first LSI sends the second LSI a request for saving the audio file that was read by the second LSI in the memory device;
the second LSI receives the saving request, and has the header information analysis unit analyze the header, and save the header analysis result in the header analysis result storage unit of the memory device;
the first LSI moves to an energy-saving state each time the process of saving a header analysis result is completed, and repeats the saving request every time when there is an audio file to be saved next while in the energy-saving state, and also moves to the energy-saving state after giving a playback instruction to the second LSI if the second LSI plays back the audio file that is saved in the memory device when the first LSI is on its way to the energy-saving state; and
the second LSI reads and plays back audio data that is saved in the memory device based on the header analysis result saved in the header analysis result storage unit while the first LSI is in the energy-saving state.

9. The music playback system of claim 1, wherein
the first LSI further comprises a header number list management unit that assigns a number to the header analysis result, and manages header numbers;
the first LSI notifies the second LSI of the header number from the header number list management unit when the second LSI plays back an audio file, then moves to an energy-saving state;
the second LSI reads the header analysis result from the header analysis result storage unit based on the notified header number from the first LSI, then based on the read header analysis result, reads and plays back the audio data that is stored in the memory device.

10. The music playback system of claim 9 wherein
the first LSI selects header numbers at random from the header number list management unit and notifies the second LSI of the header numbers, and
the second LSI plays back at random the audio files that correspond to the header numbers.

11. The music playback system of claim 9 wherein
the first LSI further comprises a play list management unit that manages a play list that was created by the user selecting audio files from among a group of audio files that are stored in the memory device; and
the first LSI selects header numbers in order that are managed by the header number list management unit according to the play list from the play list management unit, and notifies the second LSI of the header numbers.

12. The music playback system of claim 9 wherein
the first LSI further comprises a play list management unit that manages a play list that is created by the user extracting audio files from among a group of audio files stored in the memory device; and
the first LSI selects header numbers at random that are managed by the header number list management unit according to the play list from the play list management unit, and notifies the second LSI of the header numbers.

13. A music playback machine comprising:
the music playback system of claim 1; and
a key-input unit that is connected to the first LSI; wherein
the first LSI moves to an energy-saving state during playback of an audio file, and when there is key input to the key-input unit while in the energy-saving state, performs processing according to that key input.

14. A music playback machine comprising:
the music playback system of claim 8; and
a key-input unit that is connected to the first LSI; wherein
the first LSI moves to an energy-saving state during playback of an audio file, and when there is key input to the key-input unit while in the energy-saving state, performs processing according to that key input.

15. A music playback machine comprising:
the music playback system of claim 1; and
a radio communication unit that is connected to the first LSI of the music playback system; wherein
the first LSI moves to an energy-saving state during playback of an audio file, and when there is input of a radio communication signal to the radio communication unit while in the energy-saving state, performs processing according to that radio communication signal input.

16. A music playback machine comprising:
the music playback system of claim 8; and
a radio communication unit that is connected to the first LSI of the music playback system; wherein
the first LSI moves to an energy-saving state during playback of an audio file, and when there is input of a radio communication signal to the radio communication unit while in the energy-saving state, performs processing according to that radio communication signal input.
